(19) United States
(12) Patent Application Publication
(10) Pub. No.: US 2011/0290417 A1
(43) Pub. Date: Dec. 1, 2011

(54) SANDWICH GLASS FORMING MACHINE AND METHOD FOR PRODUCING A SANDWICH GLASS

(76) Inventor: Suhai Liu, Shaanxi (CN)

(21) Appl. No.: 13/125,824

(22) PCT Filed: Oct. 19, 2009
(86) PCT No.: PCT/CN2009/074515

§ 371 Date: Aug. 19, 2011

(30) Foreign Application Priority Data
Oct. 23, 2008 (CN) 200810231854.5

(51) Int. Cl. B32B 37/10; B32B 37/06

(52) U.S. Cl. 156/285; 156/382

(57) ABSTRACT

A laminated glass forming machine comprises an electro-thermal elements (1), a drawer-type multilayer structure with independent working components, a vacuum pump (3), a main vacuum chamber (4), a door sealing adhesive strip (6), a fan unit (7) and an electronic measuring and controlling device. Each layer structure of the drawer-type multilayer structure with independent working components comprises a laminated glass vacuum bag (2); and the electro-thermal elements (1) and the drawer-type multilayer structure with independent working components are arranged in the main vacuum chamber (4). A method for producing laminated glass is provided in which the above mentioned laminated glass forming machine is used. At the beginning of the vacuumization, the main vacuum chamber (4) and the laminated glass vacuum bags (2) are vacuumized simultaneously, and after a certain temperature, a certain time period and a certain vacuum degree are reached, the main vacuum chamber (4) communicates with the atmosphere for air admission, the vacuum bags (2) keep vacuum continuously, and the laminated glass is subject to an atmospheric pressure.

### TECHNICAL FIELD OF THE INVENTION

The present invention relates to a laminated sheet forming machine, in particular, to a PVB laminated glass producing device and a method for producing laminated glass.

### BACKGROUND OF THE INVENTION

Currently, the PVB film laminated glass producing equipment, domestical and abroad, adopts the following three steps: laminating in a lamination chamber with constant-temperature and constant-humidity, exhausting air by pre-heating rolling, and performing the hot-pressing formation in a high-pressure autoclave, with the electric power of the whole production line of about 200 KW, the plant area of about 300 M², the equipment investment of about RMB 1,000,000, wherein the production is under the high pressure of 1.2 Mpa˜1.4 Mpa, resulting in great danger. The EVA film laminated glass producing equipment can complete the production by one-step process, however qualified PVB film laminated glass products can not be obtained with such production.

### SUMMARY OF THE INVENTION

The technical problem to be solved by the present invention is to provide a device capable of completing the production of PVB film laminated glass by one-step process so as to reduce energy consumption.

In order to solve the technical problem above mentioned, the invention provides a laminated glass forming machine, comprising: electro-thermal elements (1), a drawer-type multilayer structure with independent working components, a vacuum pump (3), a main vacuum chamber (4), a door sealing adhesive strip (6), a fan unit (7) and an electronic measuring and controlling device, in which each layer structure of the drawer-type multilayer structure with independent working components comprises a laminated glass vacuum bag (2), and the electro-thermal elements (1) and the drawer-type multilayer structure with independent working components are arranged in the main vacuum chamber (4). The invention further provides a method for producing laminated glass, in which by using the laminated glass forming machine, at the beginning of the vacuumization, the main vacuum chamber (4) and the laminated glass vacuum bags (2) are vacuumized simultaneously, and after a certain temperature, a certain time period and a certain vacuum degree are reached, the main vacuum chamber (4) communicates with the atmosphere for air admission and the vacuum bags (2) keep vacuum, and the laminated glass is subject to an atmospheric pressure.

The electro-thermal elements (1) may be plate-shaped or tubular electro-thermal elements, and may be arranged on the one/two side(s) of the laminated glass vacuum bag (2) or on the ends thereof. The fan (7) brings the heat all over the main vacuum chamber (4) and mixes the heat uniformly.

The laminated glass vacuum bag (2) may be a rubber or plastic vacuum bag in which the laminated glass to be processed is placed, the laminated glass vacuum bag (2) and the glass to be processed can move left-right, and a plurality of laminated glass vacuum bag (2) are assembled into a multilayer structure in the form of a drawer. The main vacuum chamber (4) may be a rectangular or cylindrical structure. The laminated glass vacuum bags (2) may be arranged horizontally or vertically, and the electro-thermal elements (1), when being plate-shaped, are arranged parallel with the laminated glass vacuum bags (2). The plate-shaped electro-thermal element in each layer structure of the drawer-type multilayer structure with independent working components is independently electrically-controlled. Each laminated glass vacuum bag (2) is formed by clamping the four sides of two rubber or soft plastic plates using spring clips and long hinge clips.

The laminated glass after laminated is placed into the laminated glass vacuum bags (2) which are then pushed into the main vacuum chamber (4), and the vacuum pump (3) is started to simultaneously vacuumize the main vacuum chamber (4) and the laminated glass vacuum bags (2). When the vacuum degree reaches a certain value, the electro-thermal elements are started for heating to a certain temperature, the main vacuum chamber (4) communicates with the atmosphere for air admission, and the laminated glass vacuum bags (2) keep vacuum. The temperature continuously rises to a set value. After being preserved at this temperature for a period of time, the laminated glass vacuum bags (2) are pulled out and cooled to a certain temperature in the vacuum state, and then the laminated glass vacuum bags (2) are de-vacuumized and the finished glass products are taken out, thus the whole process is completed.

The present invention is used for producing the PVB film laminated glass, which reduces the equipment investment, lowers the power of the whole machine to 20 KW˜65 KW, and saves 60% or more of the electric energy, with the whole production process completed in one step.

### BRIEF DESCRIPTION OF THE DRAWINGS

FIG. 1-1 shows a schematic view of a rectangular structure according to the present invention; FIG. 1-2 shows a front view of a cylindrical structure according to the present invention; and FIG. 1-3 shows a left side view of the cylindrical structure according to the present invention.

### EXPLANATION OF REFERENCE NUMBERS IN THE DRAWINGS

1—electro-thermal element; 2—laminated glass vacuum bag;
3—vacuum pump; 4—main vacuum chamber;
5—door of the main vacuum chamber; 6—sealing strip for the main vacuum chamber; 7—fan unit.

### DETAILED DESCRIPTION OF THE EMBODIMENTS

The invention will be further described with reference to the accompanying drawing 1-1.

### Embodiment 1

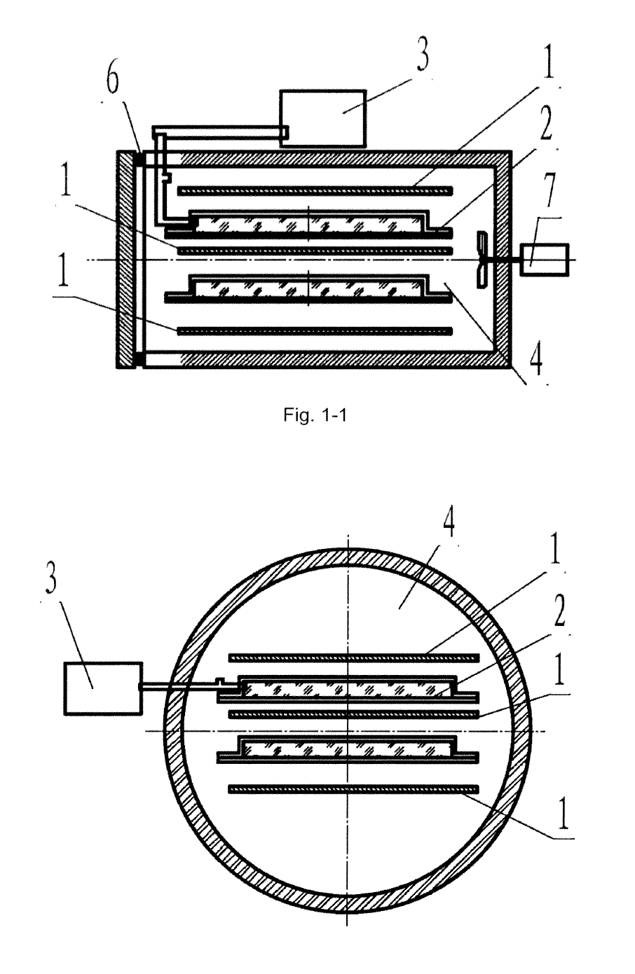

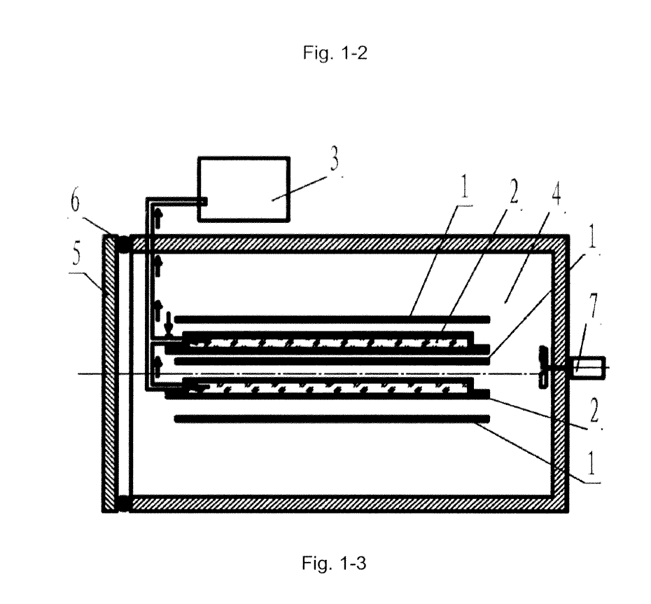

FIG. 1-1 shows a schematic view of a rectangular structure according to the present invention. The invention provides a laminated glass forming machine, comprising: electro-thermal elements 1, a drawer-type multilayer structure with independent working components, laminated glass vacuum bags 2, a vacuum pump 3, a main vacuum chamber 4, a door sealing adhesive strip 6 for the main vacuum chamber, a fan unit 7 and an electronic measuring and controlling device, in which each layer structure of the drawer-type multilayer structure with independent working components comprises a laminated glass vacuum bag 2, and the electro-thermal elements 1 and the drawer-type multilayer structure with independent working components are arranged in the main vacuum chamber 4. The present invention further provides a method for producing laminated glass in which by using the above mentioned laminated glass forming machine, at the beginning of the vacuumization, the main vacuum chamber 4 and the laminated glass vacuum bags 2 are vacuumized simultaneously. After a certain temperature (for example, 120° C.), a certain time period (for example, 60 mins) and a certain vacuum degree (for example, a relative vacuum degree of −0.092) are reached, the main vacuum chamber 4 communicates with the atmosphere for air admission and the vacuum bags 2 keep vacuum continuously (for example, with a relative vacuum degree of −0.092), and the laminated glass is subject to an atmospheric pressure. The temperature continuously rises to 135° C. and the temperature is kept for 60 minutes, after which the whole process is completed. The laminated glass vacuum bags 2 are pulled out and cooled to 45° C. in the vacuum state and then are de-vacuumized, and the finished laminated glass products are taken out.

In this embodiment, the electro-thermal elements 1 are plate-shaped electro-thermal elements and arranged on two sides of a laminated glass vacuum bags 2 so as to realize the heat dissipation without the fan 7 bringing the heat all over the main vacuum chamber 4. Of course, it is also possible to bring the heat all over the main vacuum chamber 4 by the fan 7. The laminated glass vacuum bag 2 is a silicon rubber vacuum bag in which the laminated glass which is PVB laminated glass is placed. The laminated glass vacuum bag 2 and the laminated glass to be processed can move left-right, and the laminated glass vacuum bags 2 are assembled into a multilayer structure in the form of a drawer. The plate-shaped electro-thermal element in each layer structure of the drawer-type multilayer structure with independent working components is independently electrically-controlled. Each laminated glass vacuum bag 2 is formed by clamping the four sides of two silicon rubber plates using spring clips and long hinge clips.

### Embodiment 2

FIGS. 1-2 and 1-3 show a front view and a left view of a cylindrical structure according to the present invention, respectively.

The present invention provides a laminated glass forming machine with a main vacuum chamber 4 being cylindrical. The weight of the whole machine can be reduced. The whole machine, i.e. the laminated glass forming machine, comprises electro-thermal elements 1, a drawer-type multilayer structure with independent working components, laminated glass vacuum bags 2, a vacuum pump 3, a main vacuum chamber 4, a door sealing adhesive strip 6 for the main vacuum chamber, a fan unit 7 and an electronic measuring and controlling device, in which each layer structure of the drawer-type multilayer structure with independent working components comprises a laminated glass vacuum bag 2, and the electro-thermal elements 1 and the drawer-type multilayer structure with independent working components are arranged in the main vacuum chamber 4. At the beginning of the vacuumization, the main vacuum chamber 4 and the laminated glass vacuum bags 2 are vacuumized simultaneously. After a certain temperature (for example, 100° C.), a certain time (for example, 60 mins) and a certain vacuum degree (for example, a relative vacuum degree of −0.092) are reached, the main vacuum chamber 4 communicates with the atmosphere for air admission, the vacuum bags 2 keep vacuum continuously (for example, with a relative vacuum degree of −0.092), and the laminated glass is subject to an atmospheric pressure. The temperature continuously rises to 130° C. and this temperature is kept for 60 minutes, after which the whole process is completed. The laminated glass vacuum bags 2 are pulled out and cooled to 45° C. in the vacuum state, and then are de-vacuumized, and the finished laminated glass products are taken out.

In this embodiment, the electro-thermal elements 1 are plate-shaped electro-thermal elements and arranged on two sides of the laminated glass vacuum bag 2, such that the fan 7 brings the heat all over the main vacuum chamber 4. The laminated glass vacuum bag 2 is a silicon rubber vacuum bag in which the laminated glass which is the PVB laminated glass is placed. The laminated glass vacuum bag 2 and the laminated glass to be processed can move left-right in the main vacuum chamber 4, and a plurality of laminated glass vacuum bags 2 are assembled into a multilayer structure in the form of a drawer. The plate-shaped electro-thermal element in each layer structure of the drawer-type multilayer structure with independent working components is independently electrically-controlled. Each laminated glass vacuum bag 2 is formed by clamping the four sides of two silicon rubber plates using spring clips and long hinge clips.

By virtue of the device according to the invention, a vacuum hot-pressing process can be realized, and qualified composite plate finished products free of bubbles, especially PVB film laminated glass, can be produced by using the normal-pressure process instead of the high-pressure autoclave process and leaving out the pre-heat rolling exhaust process. Processing PVB film laminated glass by using the present invention reduces the equipment investment and saves 50% or more of the electric energy.

1. A laminated glass forming machine, characterized by comprising electro-thermal elements, a drawer-type multilayer structure with independent working components, a vacuum pump, a main vacuum chamber (4), a door sealing adhesive strip, a fan unit and an electronic measuring and controlling device, wherein each layer structure of the drawer-type multilayer structure with independent working components comprises a laminated glass vacuum bag, and the electro-thermal element and the drawer-type multilayer structure with independent working components are arranged in the main vacuum chamber.

2. The laminated glass forming machine according to claim 1, characterized in that the electro-thermal elements are plate-shaped electro-thermal elements or tubular electro-thermal elements.

3. The laminated glass forming machine according to claim 1, characterized in that the electro-thermal elements are placed on two sides of the laminated glass vacuum bag or on only one side thereof or on the ends thereof and that the fan brings heat all over the main vacuum chamber and mixes the heat uniformly.

4. The laminated glass forming machine according to claim 1, characterized in that the laminated glass vacuum bag is rubber vacuum bag or plastic vacuum bag or C-shaped rubber bags in which the laminated glass to be processed is placed, wherein the laminated glass vacuum bag and the laminated glass to be processed are arranged in the main vacuum chamber movably left-right.

5. The laminated glass forming machine according to claim 1, characterized in that the main vacuum chamber is of a rectangular structure or a cylindrical structure.

6. The laminated glass forming machine according to claim 1, characterized in that the laminated glass vacuum bag is placed horizontally or vertically.

7. The laminated glass forming machine according to claim 1, characterized in that the electro-thermal elements are plate-shaped electro-thermal elements, which are placed in parallel with the laminated glass vacuum bag.

8. The laminated glass forming machine according to claim 1, characterized in that the electro-thermal element in each layer structure of the drawer-type multilayer structure with independent working components is a plate-shaped electro-thermal element independently electrically-controlled.

9. The laminated glass forming machine according to claim 1, characterized in that each laminated glass vacuum bag is formed by clamping the four sides of two rubber or soft plastic plates using spring clips and long hinge clips.

10. A method for producing laminated glass, characterized by using the laminated glass forming machine according to claim 1, wherein at the beginning of the vacuumization, the main vacuum chamber and the laminated glass vacuum bags are vacuumized simultaneously, and after a certain temperature and a certain time period are reached, the main vacuum chamber communicates with the atmosphere for air admission and the vacuum bag keeps vacuum, and the laminated glass is subject to an atmospheric pressure.
